(19) United States
(12) Patent Application Publication
(10) Pub. No.: US 2022/0074241 A1
(43) Pub. Date: Mar. 10, 2022

(54) CABLE MODULES, VEHICLES, AND VEHICLE PRODUCTION METHODS

(71) Applicants: Toyota Jidosha Kabushiki Kaisha, Toyota-shi Aichi-ken (JP); Subaru Corporation, Shibuya-ku Tokyo (JP)

(72) Inventors: Masaya Kubo, Toyota-shi Aichi-ken (JP); Akihiro Oobayashi, Shibuya-ku Tokyo (JP); Yoshinori Shinoda, Toyohashi-shi Aichi-ken (JP)

(73) Assignees: Toyota Jidosha Kabushiki Kaisha, Toyota-shi Aichi-ken (JP); Subaru Corporation, Shibuya-ku Tokyo (JP)

(21) Appl. No.: 17/404,326

(22) Filed: Aug. 17, 2021

(30) Foreign Application Priority Data
Sep. 8, 2020 (JP) 2020-150850

(51) Int. Cl. E05B 79/20; E05B 53/00

(52) U.S. Cl. CPC E05B 79/20; E05B 53/005

(57) ABSTRACT

A cable module configured to be connected to a manual release unit of an electronic lock device includes a holding member and a cable member configured to be held by the holding member. The cable member includes a grip portion and a cable configured to be connected to the grip portion. The cable member is held by the holding member in each of a first position and a second position such that a tip portion of the cable, the tip portion being located on an opposite side of the grip portion, is located outside the holding member. A length of a first portion of the cable in the first position is longer than a length of a second portion of the cable in the second position, the first portion and the second portion extending outward from the holding member.

### CROSS-REFERENCE TO RELATED APPLICATION

This application claims priority to Japanese Patent Application No. 2020-150850 filed on Sep. 8, 2020, incorporated herein by reference in its entirety.

### BACKGROUND

### 1. Technical Field

The techniques disclosed in the present specification relate to cable modules, vehicles, and methods of producing vehicles.

### 2. Description of Related Art

Japanese Unexamined Patent Application Publication No. 2017-212133 (JP 2017-212133 A) discloses a connection mechanism for connecting a charging connector to a charging inlet mounted on a vehicle. This connection mechanism has an electronic lock device that locks the charging connector to the inlet. This electronic lock device usually locks and unlocks by the driving force of a motor. In addition, this electronic lock device has an emergency release device. The emergency release device has a cable-shaped release operation unit. When an operator pulls the release operation unit, the lock by the electronic lock device is released, and the charging connector can be removed from the inlet. As described above, the lock by this electronic lock device can be manually released.

### SUMMARY

In the electronic lock device by which the lock is released when the operator pulls the cable, it is necessary to reduce the looseness of the cable. This is because if the looseness of the cable is large, it may not be possible to release the lock by the electronic lock device properly. On the other hand, when installing the electronic lock device, if the looseness of the cable is small, it becomes difficult to connect the cable to the electronic lock device. The present disclosure provides a cable module capable of connecting a cable to an electronic lock device while suppressing loosening of the cable.

The cable module according to a first aspect of the present disclosure is configured to be connected to a manual release unit of an electronic lock device. The cable module includes a holding member and a cable member configured to be held by the holding member. The cable member includes a grip portion and a cable configured to be connected to the grip portion. The holding member is configured to hold the cable member in a first position and a second position. The cable member is configured to be held by the holding member in each of the first position and the second position such that a tip portion of the cable, the tip portion being located on an opposite side of the grip portion, is located outside the holding member. A length of a first portion of the cable in the first position is longer than a length of a second portion of the cable in the second position, the first portion and the second portion extending outward from the holding member.

When connecting this cable module to the electronic lock device, first, the holding member is fixed. For example, when the cable module is connected to the electronic lock device mounted on the vehicle, the holding member can be fixed to the vehicle body. Next, the cable is connected to the manual release unit of the electronic lock device while the holding member holds the cable member in the first position. In the first position, since the length of the portion of the cable extending outward from the holding member is long, the cable can be easily connected to the manual release unit of the electronic lock device. At this stage, since the cable member is in the first position, the cable connected to the manual release unit is loose. Next, by pulling the grip portion to move the cable member from the first position to the second position, the looseness of the cable can be reduced. As described above, with the cable module according to the first aspect of the present disclosure, the cable can be easily connected to the electronic lock device in a state where the looseness of the cable is small.

A vehicle according to a second aspect of the present disclosure may have the cable module. The vehicle may include a vehicle body, an inlet, a lid configured to cover the inlet, and the electronic lock device configured to lock the lid or the inlet. The holding member may be fixed to the vehicle body. The cable may be configured to be connected to the manual release unit of the electronic lock device. The holding member may be configured to hold the cable member in the second position.

With the vehicle according to the second aspect of the present disclosure, since the cable is connected to the manual release unit of the electronic lock device in a state where the looseness of the cable is small, the lock by the electronic lock device can be easily released by pulling the cable.

A method for producing the vehicle according to a third aspect of the present disclosure may include: fixing the holding member to the vehicle body; connecting the cable to the manual release unit of the electronic lock device while the holding member holds the cable member in the first position; and moving the cable member from the first position to the second position by pulling the grip portion after connecting the cable to the manual release unit of the electronic lock device.

With the method according to the third aspect of the present disclosure, the cable can be easily connected to the electronic lock device in a state where the looseness of the cable is small.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a perspective view of a cable module when a cable member is in a first position;

FIG. 2 is a perspective view of the cable module when the cable member is in a second position;

FIG. 3 is a perspective view of a power supply port of a vehicle (a view in which a lid is omitted);

FIG. 4 is a perspective view of the power supply port of the vehicle;

FIG. 5 is an explanatory diagram of a connection process between a cable 34 and a wire 64;

FIG. 6 is an explanatory diagram of a connection process between a cable 44 and a wire 74 (a diagram in which the lid is omitted); and

FIG. 7 is an explanatory diagram of a process of moving the cables 34 and 44 from the first position to the second position (a diagram in which the lid is omitted).

### DETAILED DESCRIPTION OF EMBODIMENTS

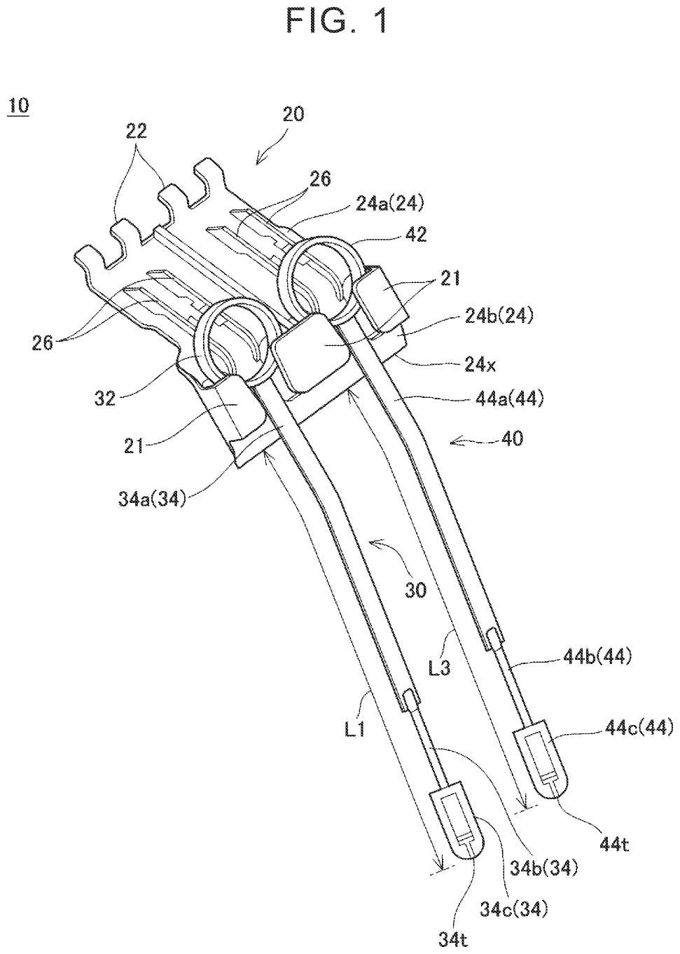

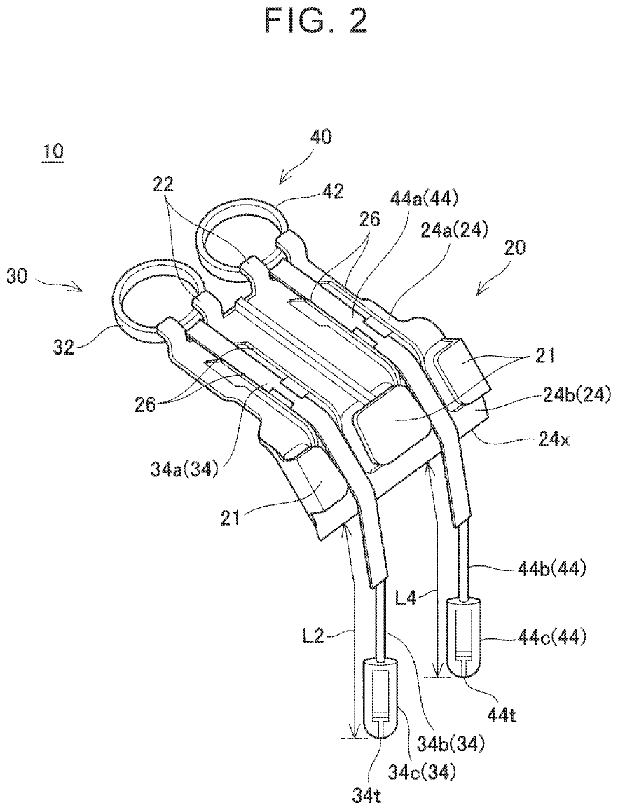

A cable module 10 of the embodiment shown in FIGS. 1 and 2 has a holding member 20 and cable members 30 and 40. The cable members 30 and 40 are held by the holding member 20. The holding member 20 can hold the cable members 30 and 40 at the positions shown in FIG. 1 and can hold the cable members 30 and 40 at the positions shown in FIG. 2.

The cable member 30 is a member made entirely of resin. The cable member 30 has a grip portion 32 and a cable 34. The grip portion 32 has a ring shape into which a human finger can be inserted. The cable 34 is connected to the grip portion 32. A main portion 34a including a portion of the cable 34 connected to the grip portion 32 is strip-shaped. A connecting portion 34c to which other members can be connected is provided at a tip 34t of the cable 34 (an end of the cable 34 on a side opposite to the grip portion 32). The main portion 34a and the connecting portion 34c are connected by an intermediate portion 34b. The cable member 40 is a member made entirely of resin. The cable member 40 has a grip portion 42 and a cable 44 (that is, a main portion 44a, an intermediate portion 44b, and a connecting portion 44c). The configuration of the cable member 40 is the same as the configuration of the cable member 30.

The holding member 20 has a base plate 24, a first stopper 21, a second stopper 22, and four guide fins 26 (two pairs of guide fins 26). The base plate 24 is a plate-shaped member, and has a horizontal portion 24a extending substantially horizontally and an inclined portion 24b extending in an inclined manner. The inclined portion 24b is provided at one end of the horizontal portion 24a. The inclined portion 24b extends diagonally downward from the horizontal portion 24a. The cable member 30 is disposed on the base plate 24 with a portion of the cable 34 on the tip 34t side extending downward from a lower end 24x of the inclined portion 24b. The cable member 40 is disposed on the base plate 24 with a portion of the cable 44 on the tip 44t side extending downward from the lower end 24x of the inclined portion 24b.

The first stopper 21 is erected on the upper surface of the inclined portion 24b. The first stopper 21 has a plurality of ends, and a space is provided between each end of the first stopper 21 and the inclined portion 24b. As shown in FIG. 1, the grip portions 32 and 42 can be inserted from above to the spaces between each end of the first stopper 21 and the inclined portion 24b and fixed. In this way, the first stopper 21 can hold the cable members 30 and 40. In the following, the positions of the cable members 30 and 40 when they are held by the first stopper 21 as shown in FIG. 1 are referred to as the first position.

The second stopper 22 is provided at the end of the horizontal portion 24a on a side opposite to the inclined portion 24b. The second stopper 22 has a plurality of claws protruding upward from the upper surface of the horizontal portion 24a. Each guide fin 26 projects upward from the upper surface of the base plate 24. Each guide fin 26 extends linearly from the upper surface of the horizontal portion 24a to the upper surface of the inclined portion 24b. Each guide fin 26 extends parallel to each other. As shown in FIG. 2, the grip portions 32 and 42 can be hooked on the claws of the second stopper 22. In this way, the second stopper 22 can hold the cable members 30 and 40. In the following, the positions of the cable members 30 and 40 when they are held by the second stopper 22 as shown in FIG. 2 are referred to as the second position. When the cable members 30 and 40 are in the second position, the main portion 34a of the cable 34 is disposed between each of the first pair of guide fins 26, and the main portion 44a of the cable 44 is disposed between each of the second pair of guide fins 26.

The cable members 30 and 40 can be moved from the first position to the second position by pulling the grip portions 32 and 42 upward when the cable members 30 and 40 are in the first position as shown in FIG. 1 and hooking them on the second stopper 22 as shown in FIG. 2. When the cable member 30 is in the first position as shown in FIG. 1, the length of the portion of the cable 34 extending outward from the holding member 20 (that is, the length from the lower end 24x of the inclined portion 24b of the holding member 20 to the tip 34t of the cable 34) is the length L1. When the cable member 30 is in the second position as shown in FIG. 2, the length of the portion of the cable 34 extending outward from the holding member 20 (that is, the length from the lower end 24x of the inclined portion 24b of the holding member 20 to the tip 34t of the cable 34) is the length L2. The length L1 is longer than the length L2. Similarly, the length of the portion of the cable 44 extending outward from the holding member 20 when the cable 44 is in the first position is longer than when the cable 44 is in the second position (that is, in FIGS. 1 and 2, L3>L4).

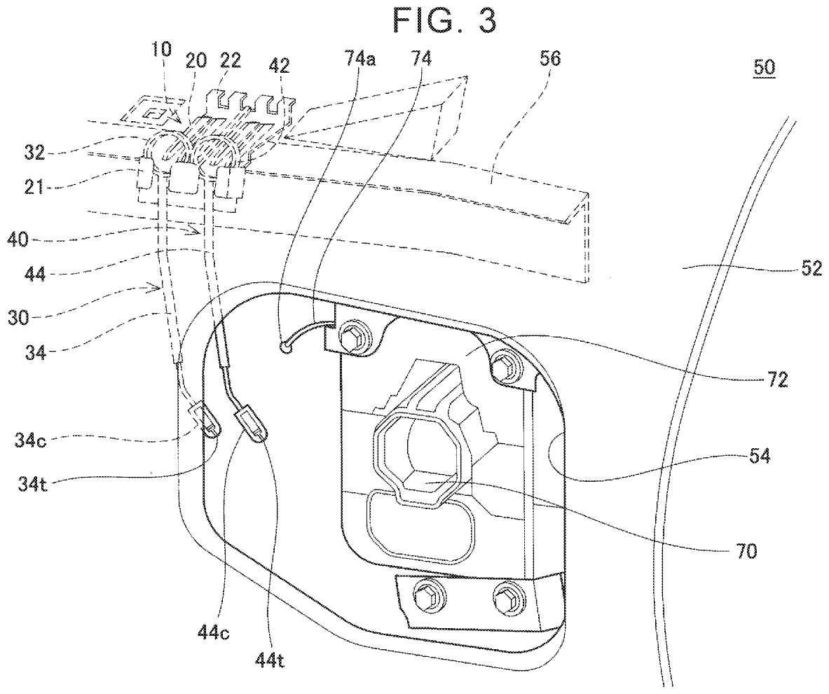

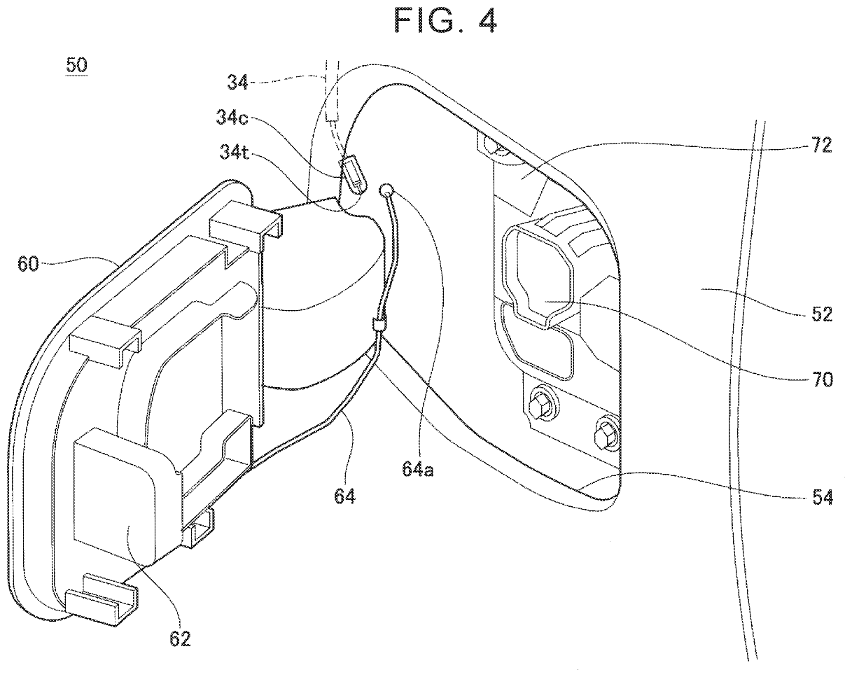

Next, a vehicle to which the cable module 10 is attached will be described. A battery is mounted on a vehicle 50 shown in FIGS. 3 and 4 and travels by using the electric power of the battery. The vehicle 50 may be an electric vehicle or a hybrid vehicle. A power supply port 54 is provided on an outer panel 52 (so-called quarter panel) of the vehicle 50. An inlet 70 for power supply is provided in the power supply port 54. As shown in FIG. 4, the vehicle 50 has a lid 60 that covers the inlet 70 (that is, the power supply port 54). The lid 60 is omitted in FIG. 3. The lid 60 shown in FIG. 4 is rotatably attached to the outer panel 52. The lid 60 can open and close the power supply port 54. By opening the lid 60 and connecting a charging connector to the inlet 70 from the outside, the battery of the vehicle 50 can be charged.

The vehicle 50 has an electronic lock device 72. The electronic lock device 72 is attached to the inlet 70. The electronic lock device 72 locks and unlocks the inlet 70 by operating a built-in actuator (for example, a motor). When the charging connector is connected to the inlet 70, the electronic lock device 72 is automatically activated to lock the charging connector to the inlet 70. When a predetermined operation is performed on the vehicle 50 or the charging device, the lock by the electronic lock device 72 is released, and the charging connector can be removed from the inlet 70. As shown in FIG. 3, the electronic lock device 72 has a wire 74. When the wire 74 is pulled while the electronic lock device 72 is locked, the lock by the electronic lock device 72 can be released without operating the actuator. That is, the wire 74 is a manual release unit for manually releasing the lock by the electronic lock device 72. Even if the actuator of the electronic lock device 72 cannot perform unlocking operation for some reason, the lock by the electronic lock device 72 is released when the wire 74 is pulled. A spherical portion 74a is provided at the tip of the wire 74.

As shown in FIG. 4, the vehicle 50 has an electronic lock device 62. The electronic lock device 62 is attached to the lid 60. The electronic lock device 62 locks and unlocks the lid 60 by operating a built-in actuator (for example, a motor). When the lid 60 is closed, the electronic lock device 62 is automatically activated to lock the lid 60. That is, opening the lid 60 is prohibited. When a predetermined operation is performed on the vehicle 50, the lock by the electronic lock device 62 is released and the lid 60 is opened. The electronic lock device 62 has a wire 64. When the wire 64 is pulled while the electronic lock device 62 is locked, the lock by the electronic lock device 62 can be released without operating the actuator. That is, the wire 64 is a manual release unit for manually releasing the lock by the electronic lock device 62. Even if the actuator of the electronic lock device 62 cannot perform unlocking operation for some reason, the lock by the electronic lock device 62 is released when the wire 64 is pulled. A spherical portion 64a is provided at the tip of the wire 64.

Next, a method of attaching the cable module 10 to the vehicle 50 will be described. As shown in FIG. 3, the vehicle 50 has a frame 56 constituting a vehicle body inside the outer panel 52. In a method of producing the vehicle 50, first, as shown in FIG. 3, the holding member 20 of the cable module 10 is fixed to the upper surface of the frame 56. Here, the holding member 20 is fixed to the frame 56 in a direction in which the grip portions 32 and 42 of the cable members 30 and 40 are located on the holding member 20. Further, when fixing the holding member 20 to the frame 56 or after fixing the holding member 20 to the frame 56, the cable members 30 and 40 are set in the first position. When the cable members 30 and 40 are set in the first position, the cables 34 and 44 hang downward from the grip portions 32 and 42.

Next, the wires 64 and 74 are connected to the cables 34 and 44, respectively, with the cable members 30 and 40 set in the first position.

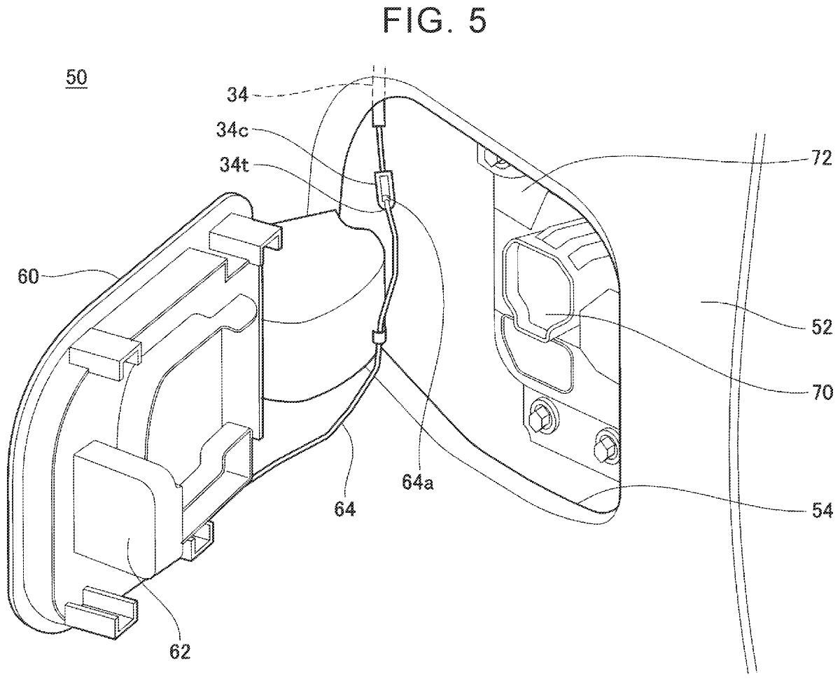

As shown in FIG. 4, a connecting portion 34c of the cable 34 has a slit. The width of the slit is narrowed at the tip 34t of the cable 34. An operator inserts the spherical portion 64a provided at the tip of the wire 64 into the slit of the connecting portion 34c, and then moves the spherical portion 64a to the tip 34t side in the slit, so that the wire 64 can be connected to the connecting portion 34c (that is, the cable 34) as shown in FIG. 5. Since the cable 34 is set in the first position as described above, the length of the portion of the cable 34 extending outward from the holding member 20 (that is, the length L1 in FIG. 1) is long. Therefore, the length of the cable 34 is long enough for the operator to easily connect the wire 64 to the cable 34. After connecting the wire 64 to the cable 34, the lid 60 is closed. Closing the lid 60 increases the looseness of the cable 34 and wire 64.

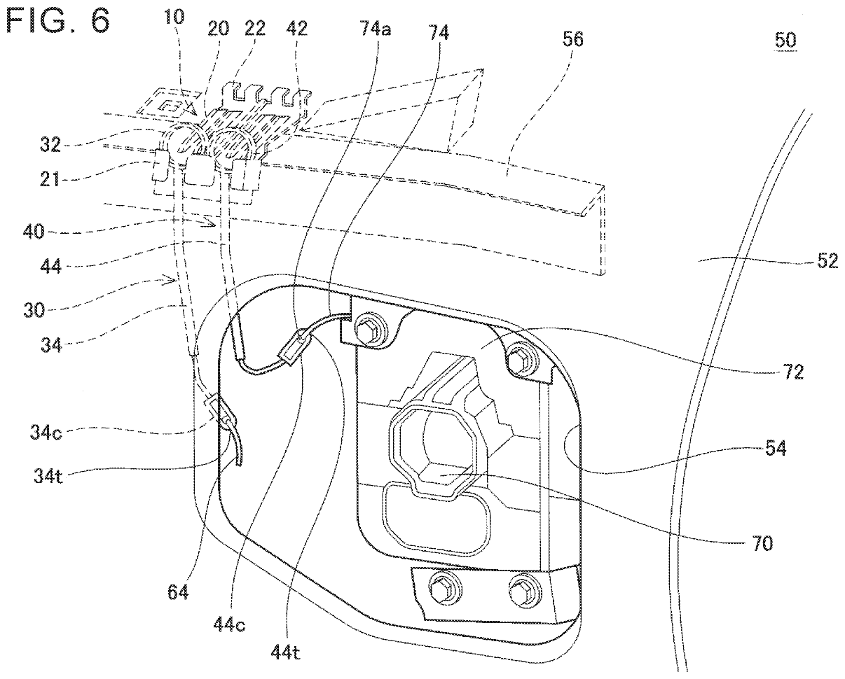

As shown in FIG. 3, the connecting portion 44c of the cable 44 has a slit. The width of the slit is narrowed at the tip 44t of the cable 44. An operator inserts the spherical portion 74a provided at the tip of the wire 74 into the slit of the connecting portion 44c, and then moves the spherical portion 74a to the tip 44t side in the slit, so that the wire 74 can be connected to the connecting portion 44c (that is, the cable 44) as shown in FIG. 6. Since the cable 44 is set in the first position as described above, the length of the portion of the cable 44 extending outward from the holding member 20 (that is, the length L3 in FIG. 1) is long. Therefore, the length of the cable 44 is long enough for the operator to easily connect the wire 74 to the cable 44. At this stage, the cable 44 and the wire 74 are in a loose state.

Next, by moving the cable members 30 and 40 to the second position, the looseness of the cables 34 and 44 is reduced.

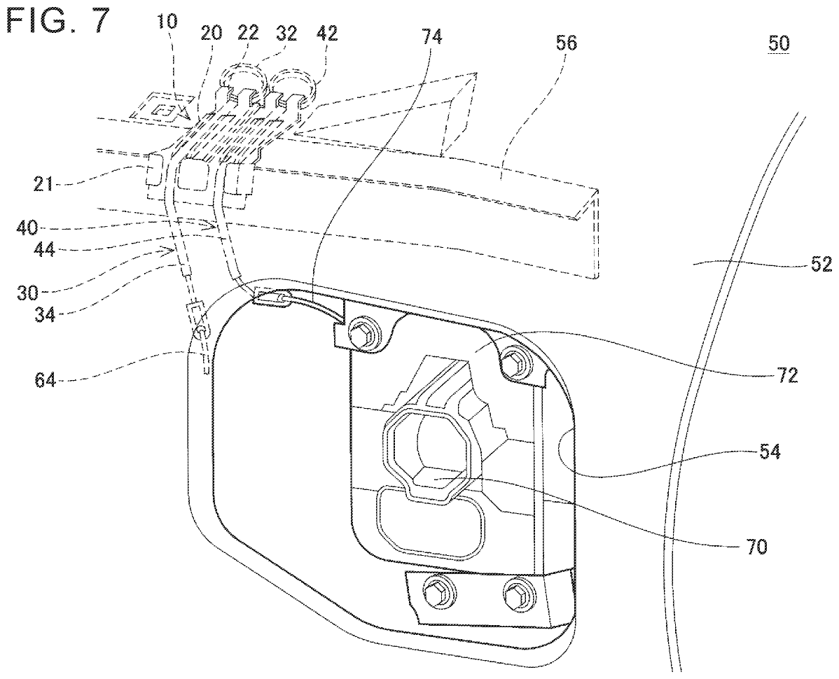

The operator can move the cable member 30 from the first position to the second position as shown in FIG. 7 by pulling the grip portion 32 of the cable member 30 upward and hooking it on the second stopper 22. As described above, when the cable member 30 is in the first position, the cable 34 and the wire 64 are loosened. When the cable member 30 is moved from the first position to the second position, the length of the portion of the cable 34 extending outward from the holding member 20 decreases from the length L1 shown in FIG. 1 to the length L2 shown in FIG. 2. Therefore, as shown in FIG. 7, when the cable member 30 is moved to the second position, the looseness of the cable 34 and the wire 64 is reduced.

The operator can move the cable member 40 from the first position to the second position as shown in FIG. 7 by pulling the grip portion 42 of the cable member 40 upward and hooking it on the second stopper 22. As described above, when the cable member 40 is in the first position, the cable 44 and the wire 74 are loosened. When the cable member 40 is moved from the first position to the second position, the length of the portion of the cable 44 extending outward from the holding member 20 decreases from the length L3 shown in FIG. 1 to the length L4 shown in FIG. 2. Therefore, as shown in FIG. 7, when the cable member 40 is moved to the second position, the looseness of the cable 44 and the wire 74 is reduced.

As described above, according to the above production method, the cables 34 and 44 can be connected to the wires 64 and 74, respectively, with the cables 34 and 44 having a margin, so that the operator can easily perform the connection work. Next, by moving the cable members 30 and 40 to the second position, the looseness of the cables 34 and 44 can be reduced. Therefore, the vehicle 50 can be shipped in a state in which the looseness of the cables 34 and 44 is small.

When the lock by the electronic lock devices 62 and 72 (that is, the lock of the lid 60 or the inlet 70) cannot be electrically released due to some abnormality while the vehicle 50 is in use, the lock can be released manually.

When the lock by the electronic lock device 62 (that is, the lock of the lid 60) is released by a manual operation, the operator of the manual operation can pull the grip portion 32 (the grip portion 32 in the second position) of the cable member 30. When the grip portion 32 is pulled, the wire 64 is pulled through the cable 34, and the lock by the electronic lock device 62 is released. At this time, if the cable 34 and the wire 64 are much loosened, the operator of the manual operation cannot feel the tension when pulling the grip portion 32. Therefore, it is difficult to determine whether the work is being performed correctly. On the other hand, in the vehicle 50 produced by the above production method, the cable 34 and the wire 64 are less loosened, so that the operator of the manual operation can feel the tension when pulling the grip portion 32. Further, since the looseness of the cable 34 and the wire 64 is small, the lock is released when the grip portion 32 is pulled by a small amount. Therefore, it is possible to suppress the operator from being confused about the determination. The operator can correctly release the lock by the electronic lock device 62.

When the lock by the electronic lock device 72 (that is, the lock of the inlet 70) is released by a manual operation, the operator of the manual operation can pull the grip portion 42 (the grip portion 42 in the second position) of the cable member 40. When the grip portion 42 is pulled, the wire 74 is pulled through the cable 44, and the lock by the electronic lock device 72 is released. At this time, if the cable 44 and the wire 74 are much loosened, the operator of the manual operation cannot feel the tension when pulling the grip portion 42. Therefore, it is difficult to determine whether the work is being performed correctly. On the other hand, in the vehicle 50 produced by the above production method, the cable 44 and the wire 74 are less loosened, so that the operator of the manual operation can feel the tension when pulling the grip portion 42. Further, since the looseness of the cable 44 and the wire 74 is small, the lock is released when the grip portion 42 is pulled by a small amount. Therefore, it is possible to suppress the operator from being confused about the determination. The operator can correctly release the lock by the electronic lock device 72.

Although the embodiments have been described in detail above, the embodiments are merely examples and do not limit the scope of claims. The techniques described in the claims include various modifications and alternations of the specific examples illustrated above. The technical elements described in the present specification or the drawings exhibit technical usefulness alone or in various combinations, and are not limited to the combinations described in the claims at the time of filing. In addition, the techniques illustrated in the present specification or drawings achieve a plurality of objectives at the same time, and achieving one of the objectives itself has technical usefulness.

What is claimed is:

1. A cable module configured to be connected to a manual release unit of an electronic lock device, the cable module comprising:
a holding member; and
a cable member configured to be held by the holding member, the cable member including a grip portion and a cable configured to be connected to the grip portion, wherein:
the holding member is configured to hold the cable member in a first position and a second position;
the cable member is configured to be held by the holding member in each of the first position and the second position such that a tip portion of the cable, the tip portion being located on an opposite side of the grip portion, is located outside the holding member; and
a length of a first portion of the cable in the first position is longer than a length of a second portion of the cable in the second position, the first portion and the second portion extending outward from the holding member.

2. A vehicle including the cable module according to claim 1, the vehicle comprising:
a vehicle body;
an inlet;
a lid configured to cover the inlet; and
the electronic lock device configured to lock the inlet or the lid, wherein:
the holding member is fixed to the vehicle body;
the cable is configured to be connected to the manual release unit of the electronic lock device; and
the holding member is configured to hold the cable member in the second position.

3. A method for producing the vehicle according to claim 2, the method comprising:
fixing the holding member to the vehicle body;
connecting the cable to the manual release unit of the electronic lock device while the holding member holds the cable member in the first position; and
moving the cable member from the first position to the second position by pulling the grip portion after connecting the cable to the manual release unit of the electronic lock device.
